(19) United States
(12) Patent Application Publication
(10) Pub. No.: US 2007/0023593 A1
(43) Pub. Date: Feb. 1, 2007

(54) Flat panel display mounting apparatus and system

(76) Inventor: Dale Fedewa, Phoenix, AZ (US)

Correspondence Address: KUNZLER & ASSOCIATES, 8 EAST BROADWAY, SUITE 600, SALT LAKE CITY, UT, 84111, US

(21) Appl. No.: 11/189,513

(22) Filed: Jul. 26, 2005

(51) Int. Cl. F16M 11/00

(52) U.S. Cl. 248/201; 248/919

(57) ABSTRACT

A display mounting apparatus and system can be adjusted in differing ways, separately or in combination, including tilting, panning, and translational movement vertically, horizontally, and perpendicular to the wall or other mounting surface. The apparatus comprises two mounting assemblies spaced at variable distances from each other, each assembly comprising a mounting bracket, a scissors mounting assembly attached to the mounting bracket at a plurality of points, and a tilt bracket to which the scissors assembly attaches at one point, the tilt bracket being configured to swivel around the scissors assembly attachment point. Each tilt bracket can be moved perpendicular to the wall by varying the attachment locations of the scissors assembly to the mounting bracket. A horizontal cross member is slidably attached to the tilt brackets, and vertical attachment members configured for attachment to the display at a plurality of points are slidably attached to the horizontal cross member.

### BACKGROUND OF THE INVENTION

1. Field of the Invention

This invention relates to mounting systems, and more particularly to a flat-panel display mounting apparatus, which enables the display to be attached to a mounting surface and positioned at an optimum viewing location and angle.

2. Description of the Related Art

The popularity of electronic flat-panel displays, such as for televisions and computers, has greatly increased in recent years as such displays have become increasingly available and inexpensive. Currently manufactured and marketed displays come in a variety of different sizes and types, including liquid-crystal, light-emitting-diode, and plasma screens. Given that they are thinner than traditional cathode-ray or projection displays, these displays may be positioned or mounted in a commensurately large variety of places and ways; particularly, as is becoming increasingly popular, on a wall or similar mounting surface. Ways of mounting the displays range from simple devices that basically hang the display on the wall like a picture to large mounting systems that enable position adjustment or other features.

Some of these latter systems comprise a display attachment that is cantilevered away from the wall such that the position of the display can be adjusted. Others comprise adjustable protrusions of various sorts to allow for limited position and orientation adjustment—most commonly, the angle at which the display is tilted (rotationally tilting the display up or down relative to the wall or other mounting surface). It should be noted, however, that degree of tilt is only one of many different possible position adjustments. Others include panning (similar to tilting, except that instead of up and down the display is rotationally panned side to side), translational depth (the distance the display is located from the wall), translational vertical positioning, and translational horizontal positioning.

In an attempt to create better adjustability, some existing systems use protrusions that extend away from a single point of attachment to the wall. Given their design, however, such systems are often limited in their capabilities, and systems that allow for wider adjustment of the display are generally expensive, heavy, and large, limiting the surfaces on which a flat-panel display can be mounted.

Other systems can adjust the display in only one or two of the several possible different ways of adjusting.

Generally, the more numerous the ways of adjusting position and orientation in mounting systems, the larger, more expensive, and more complex the mounting system becomes. Some existing mounting systems take up 1,500 cubic inches of space, limiting the locations in which they may be placed.

The complex nature of many mounting systems also detracts from the sleek aesthetic appeal of the flat-panel display, which is one of the primary reasons consumers purchase such displays in the first place.

Many mounting systems are further limited in that they are unable to accommodate more than one or a few of the large variety of screens offered by different manufacturers—and often the same manufacturer—which can vary in weight, height, depth, breadth, delicacy, and method of mounting.

From the foregoing discussion, it should be apparent that a need exists for an apparatus and system that allows for adjustment of the flat-panel display in as optimal a viewing position as possible, using as many different types of adjustment as possible, while minimizing disadvantages such as high cost, weight, and bulkiness. Beneficially, such an apparatus, system, and method would also accommodate a large number of displays of differing manufacture and size.

### SUMMARY OF THE INVENTION

The present invention has been developed in response to the present state of the art, and in response to the problems and needs in the art that have not yet been fully solved by currently available display mounting apparatuses and systems. Inparticular, the invention addresses the adjustment capabilities of display mounting systems while minimizing problems of cost, complexity, and size.

In accordance with one aspect of the present invention, a display mounting apparatus comprises a mounting bracket adapted for attachment to a mounting surface, an attachment bracket for attachment to the display, a first arm whose proximate end is attached to the mounting bracket and whose distal end is attached to the attachment bracket at a first attachment point, and a second arm attached in similar fashion to the first arm. The second arm's proximate end attachment on the mounting bracket is spaced from the mounting bracket attachment point of the first arm, and the two arms' distal ends are attached at approximately the same point on the attachment bracket.

The second arm is positioned substantially below the first arm in one embodiment, and the mounting bracket contains a plurality of attachment points disposed substantially vertically thereon, enabling the first and second arms to be attached at various points along the mounting bracket. In this manner, the attachment bracket and display are translationally positioned closer to the mounting surface when the arms are attached to the mounting bracket at attachment points farther from each other, and the attachment bracket and display are translationally positioned farther from the mounting surface when the arms are attached to the mounting bracket at attachment points closer to each other.

The height of the display corresponds to the height of the attachment points of the first and second arms on the mounting bracket.

In one embodiment, the attachment bracket comprises a tilt bracket, with the first attachment point being positioned on the tilt bracket. The tilt bracket is configured to rotate around the attachment point of the arms, allowing for tilting movement of the display.

A cross member is provided for attachment to the tilt bracket, the cross member being adapted for horizontal movement through the tilt bracket. Two vertical attachment members are adapted for attachment to the cross member along any point of the cross member, the vertical attachment members being further configured for attachment to the display.

The vertical attachment members contain a plurality of attachment points whereby the display can be attached, allowing for a plurality of positions of the display relative to the vertical attachment member. Extension members can be provided to extend the length of the vertical attachment members and provide further attachment points.

The mounting bracket, first arm, second arm, and tilt bracket collectively constitute a first mounting assembly. The apparatus further comprises a second mounting assembly of similar construction to the first, the second mounting bracket being adapted for attachment to the mounting surface horizontally spaced from the location at which the first mounting bracket is attached. The second tilt bracket is configured for attachment to the cross member horizontally spaced from the attachment of the first tilt bracket, enabling the display to be panned by positioning the first tilt bracket and mounting bracket closer to each other than the second tilt bracket and mounting bracket.

In one embodiment, therefore, the apparatus is configured for adjustment of the display in five different ways, separately or in combination: 1) tilting the display around a horizontal axis; 2) panning the display around a vertical axis; 3) translationally moving the display toward or away from the mounting surface; 4) translationally moving the display vertically; and 5) translationally moving the display horizontally.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that they depict only typical embodiments of the invention and are not therefore to be considered to be limiting of its scope, the invention will be described and explained with additional specificity and detail through the use of the drawings, in which:

FIG. 1 is a rearward perspective view illustrating one embodiment of a flat panel display mounting apparatus in accordance with one aspect of the present invention;

FIG. 1A is a front elevational view of the vertical attachment member and vertical extension member used in the apparatus of FIG. 1;

FIG. 1B is a side elevational view of the vertical attachment member, vertical extension member, and flat-panel display used in the apparatus of FIG. 1;

FIG. 1C is a perspective view of the horizontal cross member used in the apparatus of FIG. 1;

FIG. 2 is an exploded rearward perspective view of a mounting subassembly used in the flat panel display mounting apparatus shown in FIG. 1, showing further details of the individual components;

FIG. 3 is a rearward perspective view of the flat panel display mounting apparatus shown in FIG. 1, with the flat-panel display having been panned, tilted, and translationally moved vertically and horizontally;

FIG. 4 is a side view of the flat-panel display mounting apparatus shown in FIG. 1, with the flat-panel display having been translationally moved toward the mounting surface;

FIG. 5 is a side view schematic diagram showing translational movement of the flat-panel display toward and away from the mounting surface in accordance with an aspect of the present invention;

FIG. 6 is a side view schematic diagram showing vertical translational movement of the flat-panel display in accordance with an aspect of the present invention;

FIG. 7 is a top view schematic diagram showing horizontal translational movement of the flat-panel display in accordance with an aspect of the present invention;

FIG. 8 is a top view schematic diagram showing rotational panning movement of the flat-panel display in accordance with an aspect of the present invention; and

FIG. 9 is a side view schematic diagram showing rotational tilting movement of the flat-panel display in accordance with an aspect of the present invention.

### DETAILED DESCRIPTION OF THE INVENTION

It will be understood that the components of the present invention, as generally described and illustrated in the figures herein, may be arranged and designed in a wide variety of different configurations. Thus, the following, more detailed, description of the embodiments of the apparatus, system, and method of the present invention is not intended to limit the scope of the invention as claimed, but is merely representative of selected embodiments.

The illustrated embodiments of the invention will be best understood by reference to the drawings, wherein like parts are designated by like numerals throughout. Those of ordinary skill in the art will appreciate that various modifications to the devices, systems, and processes may readily be made without departing from the essential characteristics of the invention. Thus, the following description is intended only by way of example, illustrating certain selected embodiments of devices, systems, and processes that are consistent with the invention as claimed herein.

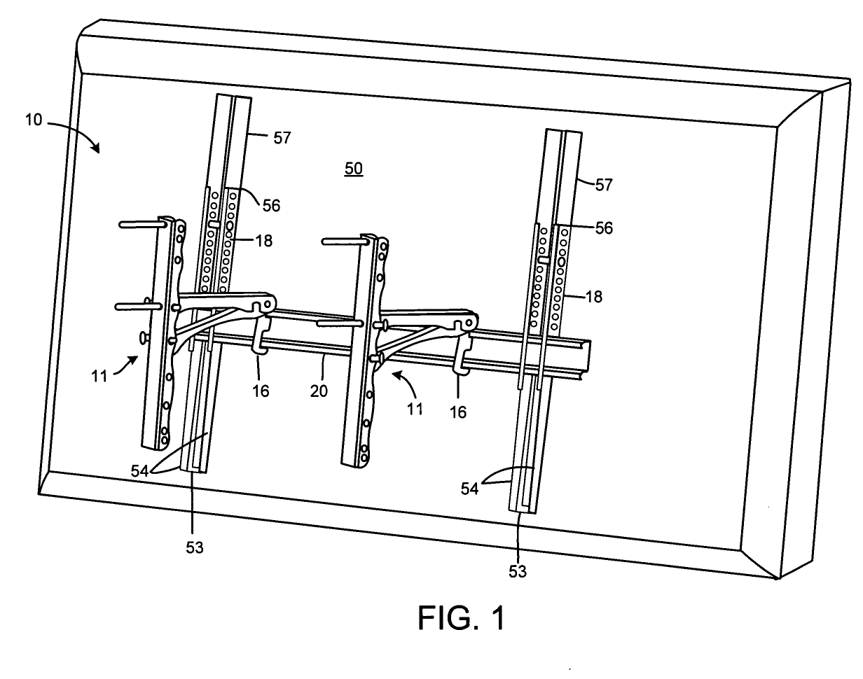

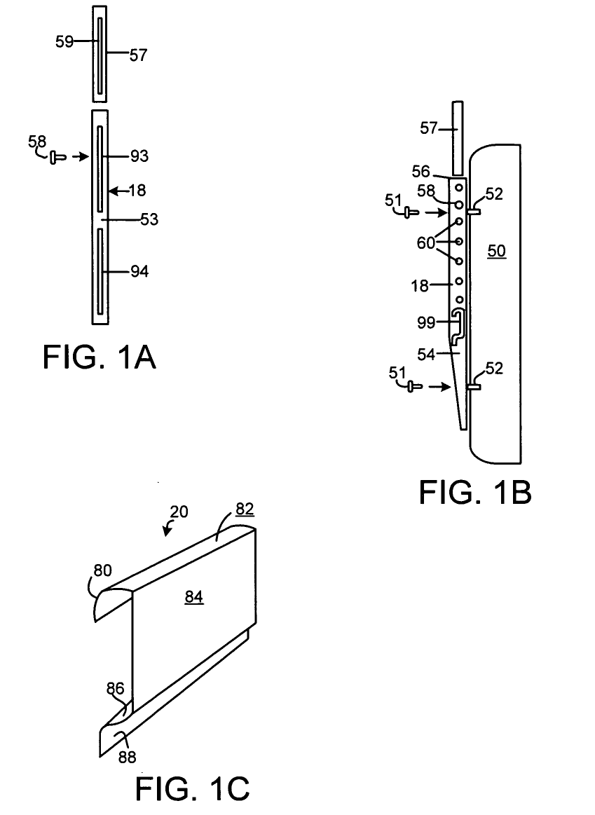

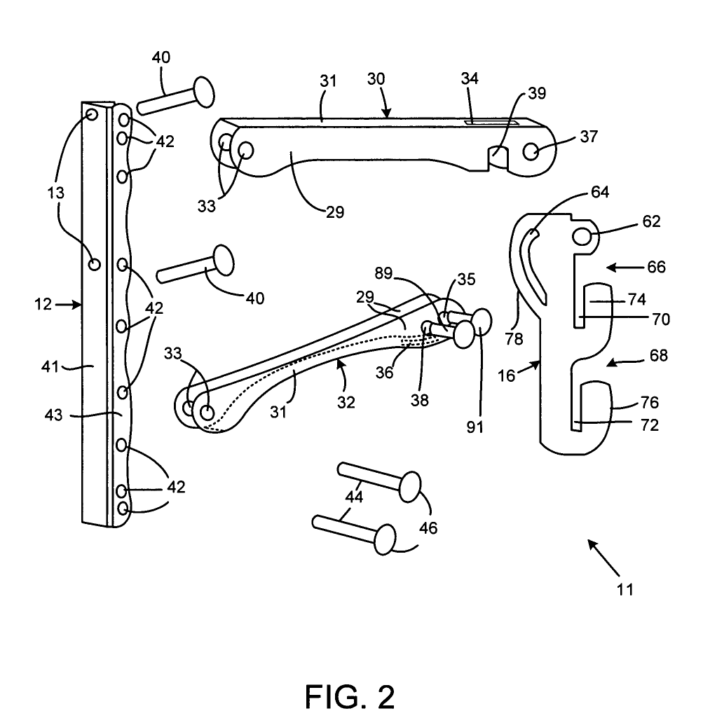

Referring first to FIGS. 1 and 2, an embodiment of a flat-panel display mounting apparatus 10 in accordance with one aspect of the invention is shown. The apparatus 10 is used to mount a flat-panel display 50.

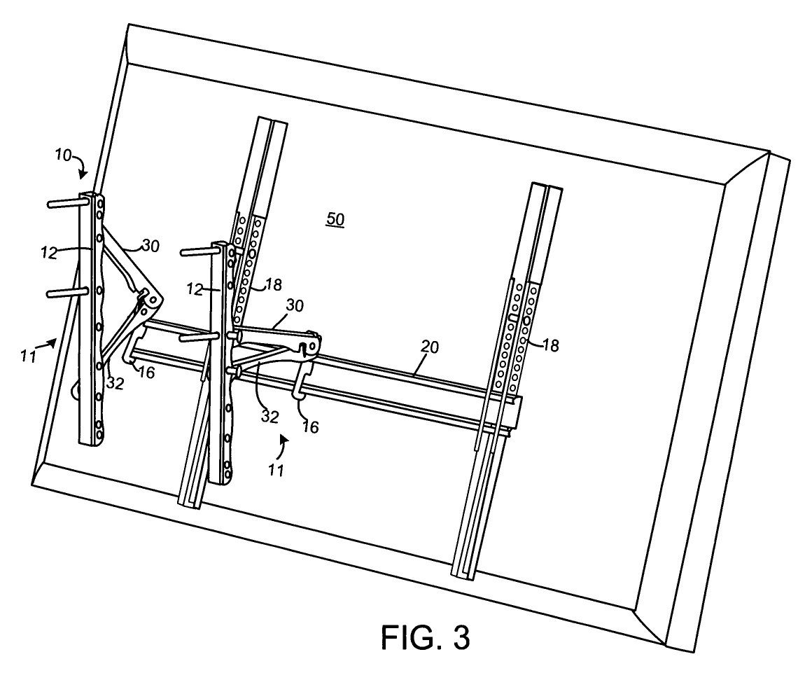

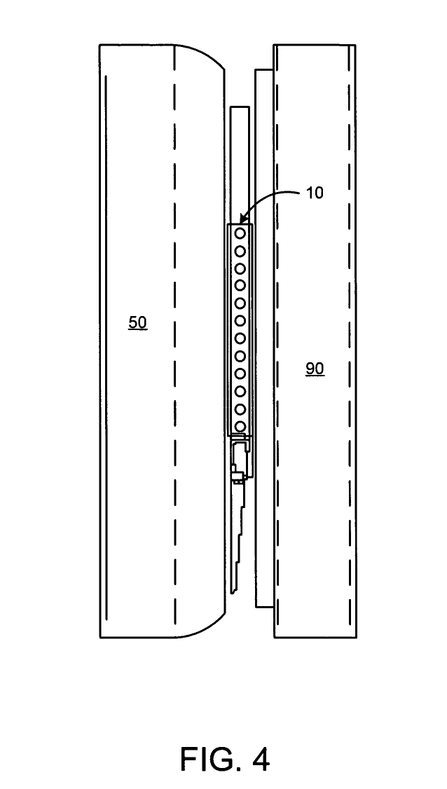

The mounting apparatus 10 comprises two mounting subassemblies 11, each of which is constructed substantially identically. Referring particularly to FIG. 2, each of the mounting subassemblies 11 conains a mounting bracket 12. The mounting bracket 12, which can be constructed of metal or composite or other suitable material, is elongated, with a center portion 41 and flanges 43 extending at right angles from each lengthwise edge of the center portion 41. The center portion 41 contains through holes 13 through which mounting screws 40 pass to attach the mounting bracket 12 to a wall or other mounting surface, shown as wall 90 in FIG. 4. The flanges 43 contain through-hole pairs 42, each pair of holes 42 being oriented horizontally of each other, through which fasteners 44 are adapted to pass. The fasteners 44 may be constructed in any suitable way, such as a rod containing a ring 46 on the end for facile extraction from the through holes 42. The number of holes 13 and 42 may of course vary from the exact number of holes shown in the drawings, or may be replaced by slots (with or without steps or detents) or other configurations apparent to those skilled in the art in light of this disclosure.

Each subassembly 11 further comprises an upper arm 30 and a lower arm 32, each arm being elongated and containing a center portion 31 and flanges 29 extending from the edges of the center portion 31, similar to the shape of mounting brackets 12. A pair of through holes 33 extends through the flanges 29 on one end of each arm, upper and lower, the through holes 33 being adapted to match with the through hole pairs 42 such that each fastener 44 can pass through one of the pairs of holes 42 and one of the pairs of holes 33 when the latter are placed in matching engagement with the former, fixing the arm 30 or 32 in place on mounting bracket 12. The holes 33 on the upper arm 30 are adapted for placement between the mounting bracket flanges 43 at a higher location than the holes 33.

The upper and lower arms 30 and 32 can be constructed of metal or composite or other material of suitable strength for the purpose.

The upper arm 30 contains a slot opening 34 on the end opposite the through holes 33, in the center portion 31. It further contains a pair of through holes 37 extending through the flanges 29 toward the end of the upper arm 30 opposite the holes 33, and a pair of slots 39 disposed in the flanges 29.

The lower arm 32 contains a slot opening 36 in its center portion 31, similar 27 to the slot opening 34 in the upper arm 30. The lower arm 32 further contains a pair of holes 35 extending through the flanges 29, the through holes 35 corresponding to the through holes 37 in the upper arm 30. The lower arm 32 further contains a pair of tilt-adjust holes 38 extending through the flanges 29, above the slot opening 36.

Each subassembly 11 further comprises a tilt or swivel bracket 16, adapted for attachment to the upper and lower arms 30 and 32. The tilt bracket 16 has an outer curved edge 78 that allows for smooth movement within the slot openings 34 and 36 when the tilt bracket 16 is attached to the upper and lower arms 30 and 32. A curved slot opening 64 is disposed near the outer edge 78 of the tilt bracket 16. A hole 62 is disposed in the tilt bracket 16 at or near the focus of the curved slot opening 64. An upper opening 66 and lower opening 68 are disposed in the edge of the tilt bracket 16 opposite the side of the curved outer edge 78. The upper and lower openings 66 and 68 each contain a recessed portion 70 and 72, respectively, creating upper and lower raised portions or hooks 74 and 76, respectively.

The tilt bracket 16 is attached to the upper and lower arms 30 and 32 by means of a bolt 91 that is adapted to pass through the holes 35, 37, and 62. The bolt 91 can be tightened with a corresponding nut or other suitable means. In one embodiment the tilt bracket 16 is centered within the slot openings 34 and 36 in the upper and lower arms 30 and 32 by means of one or more washers or other type of spacer devices.

It will be apparent to those skilled in the art that the lower arm 32 is slightly narrower than the upper arm 30 in order for the lower arm 32 to fit within the flanges 29 of the upper arm 30. The tilt bracket 16 is further attached to the lower arm 32 by means of a bolt 89, which passes through the holes 38, curved slot 64, and, in certain orientations, the slots 39. When tightened, the bolts 91 and 89 serve to fix the arms 30 and 32 and tilt bracket 16 together in pivotal engagement.

Alternatively, the upper and lower arms 30 and 32 can be constructed as a single arm, with an articulating joint at the point where the arm attaches to the tilt bracket 16. Other arrangements while remaining within the scope of the invention will be apparent to those skilled in the art in light of this disclosure.

The arms 30 and 32 are adapted to move relative to each other much like the cutting arms of a pair of scissors, and may be viewed collectively as a scissors assembly.

The upper and lower arms 30 and 32 can be rotated around the bolt 91, which serves as a horizontal axis of rotation, by loosening (though, in one mode of operation, not completely undoing) the bolt 89, rotating the arms 30 and 32 to their desired positions (so that, for example, the holes 33 match up with a desired pair of holes 42 on the mounting bracket 12), and retightening the bolt 89.

The tilt bracket 16 can also be rotated around the bolt 91. The curved slot 64 allows such rotation by allowing the bolt 89 to move through it, the ends of the slot 64 acting as the delimiters of the rotational movement. As a practical matter, the movement will also be limited by the space between the display 50 and the wall 90.

As shown in FIG. 3, by means of mounting attachments described below, by rotating the tilt bracket 16 the flat-panel display 50 is tilted to whatever degree of rotation the tilt bracket 16 attains.

When the upper and lower arms 30 and 32 are attached to the tilt bracket 16 as described above, the tilt bracket 16 can be brought closer to or farther away from the mounting bracket 12 —and thus the wall 90 or other surface on which the mounting bracket 12 is mounted —by varying the locations at which the upper and lower arms 30 and 32 are attached to the mounting bracket 12. To bring the tilt bracket 16 closer to the mounting bracket 12, the upper arm 30 is attached to the mounting bracket 12 at a high position (matching the holes 33 and 42 and placing the fastener 44 therethrough) relative to the position at which the lower arm 32 is attached to the mounting bracket 12.

Increasing the distance between the attachment points of the upper and lower arms 30 and 32 to the mounting bracket 12 effectively shortens the reach of the arms 30 and 32 and draws the tilt bracket 16 closer to the mounting bracket 12. Conversely, the tilt bracket 16 can be spaced farther away from the mounting bracket 12 by decreasing the distance between the attachment points of the upper and lower arms 30 and 32 to the mounting bracket 12.

It will be apparent that by this means the tilt bracket 16, together with the flat-panel display 50 attached thereto, can be translationally moved toward or away from the wall by increasing or decreasing the distance between the attachment points of the upper and lower arms 30 and 32 with the mounting bracket 12. FIG. 1 shows one configuration in which the display 50 is spaced from the wall, and FIG. 4 shows another configuration in which the display 50 has been moved closer to the wall 90 through the above-explained procedure.

Given that there are two mounting subassemblies 11, the principle of spacing the upper and lower arms 30 and 32 on the mounting bracket 12 to move the tilt bracket 16 closer to or farther away from the wall or other mounting surface can also be used to pan—that is, rotationally move around a vertical axis—the flat-panel display 50 by moving one tilt bracket 16 closer to its mounting bracket 12 than the other tilt bracket 16, as shown in FIG. 3. In an alternative embodiment of the present invention, a single mounting subassembly 11 can be used to mount the flat-panel display 50. Such an embodiment would also allow for orientation and positional adjustment of the flat-panel display 50, though it would not allow for panning.

The tilt bracket 16 can also be raised or lowered by raising or lowering the attachment points of the arms 30 and 32 on the mounting bracket 12 by an equal amount, resulting in vertical translational movement of the tilt bracket 16 and flat-panel display 50 attached thereto.

Referring again to FIG. 1, in one embodiment of the invention the tilt bracket 16 is attached to the flat-panel display 50 by means of vertical attachment members 18 and a horizontal cross member 20, which, by their construction and arrangement, also allow for further adjustment of the position of the flat-panel display 50. Each vertical attachment member 18 is elongated and constructed with a center portion 53 and flanges 54 extending from the edges of the center portion 53. The flanges 54 impart strength to the vertical attachment member 18, and they also accommodate the placement of the horizontal cross member 20, as described below. Both the vertical attachment members 18 and horizontal cross member 20 can be constructed of metal or composite or other suitable material.

Referring to FIGS. 1A and 1B, each vertical attachment member 18 contains an upper slot 93 in the upper part of its center portion 53, and a lower slot 94 in the lower part of its center portion 53. The slots 93 and 94 accommodate screws 51 or other attachment devices, which attach to the flat-panel display 50 by threaded mounting holes 52. The vertical attachment members 18 can be attached to a wide variety of flat-panel displays 50, each with its own particular placement of the mounting holes 52, due to the slots 93 and 94 accommodating screws 51 in numerous positions along the length of the slots, which allows for a wide variety of vertical placement of the mounting holes 52. In addition, the vertical attachment members 18 can be moved horizontally to accommodate differences in horizontal placement of the mounting holes 52. It will also be apparent from this disclosure that the flat-panel display 50 can be moved translationally up or down by moving the screws 51 along the slots 93 and 94, augmenting or replacing the translational movement of the flat-panel screen 50 through the subassemblies 11, described above.

The vertical attachment members 18 further contain a plurality of paired holes 60 in flanges 54. Flat-panel displays currently have screens with sizes up to approximately 84 inches. Should the mounting holes 52 be spaced at a distance that is longer than a vertical attachment member 18 can accommodate, a vertical extension member 57, of similar construction to the vertical attachment members 18 (albeit somewhat narrower such that it can fit within the vertical attachment member 18) can be employed. The vertical extension member 57 can be inserted into the top portion 56 of the vertical attachment member 18, allowing gravity to pull it through until the top portion 56 abuts a bolt 58 disposed through a selected hole pair 60. Each vertical extension member 57 contains a slot 59 for placement of the screws 51 into the mounting holes 52 of the flat-panel display 50.

Each vertical attachment member 18 contains an opening 99 for accommodation of the horizontal cross member 20 in sliding engagement. The vertical attachment members 18 can be moved independently along the horizontal cross member 20, as needed, for the slots 93 and 94 to meet with the mounting holes 52. In addition, as shown in FIG. 3, the vertical attachment members 18 can be moved in concert relative to the cross member 20 to translationally move the flat panel display 50 horizontally to one side or the other, as desired.

As shown particularly in FIG. 1C, the horizontal cross member 20 is elongated and shaped in cross-section such that it attaches to the tilt brackets 16 in secure engagement. The cross member 20 comprises a center portion 84, an upper edge portion 82 extending from the upper part of the center portion 84, and an upper flange 80 extending downward from the upper edge portion 82. When engaging the tilt bracket 16, the upper flange 80 enters the upper opening 66 of the tilt bracket 16 and rests in the upper recess 70, with the upper edge portion 82 resting on the upper hook 74.

A lower edge portion 86 extends from the lower part of the center portion 84 of the cross member 20, and a lower flange 88 extends downward from the lower edge portion 86. When engaging the tilt bracket 16, the lower flange 88 enters the lower opening 68 of the tilt bracket 16 and rests in the lower recess 72, with the lower edge portion 86 resting on the lower hook 76.

In addition to the vertical attachment members 18 moving relative to the horizontal cross member 20 for translational lateral movement of the flat-panel display 50, the display 50 may be laterally moved by sliding the cross member 20 through the tilt brackets 16.

The cross member 20 can generally be coupled to the tilt bracket 16 regardless of the position and/or orientation of the mounting subassemblies 11 including the degree of tilting rotation of the tilt bracket 16 or translational position of the vertical attachment members 18.

In one embodiment adapted to mount currently manufactured flat-panel displays, the apparatus 10 requires no more than 119 square inches of wall space and 550 cubic inches of space away from the wall, allowing for more flexibility in placement than many existing systems.

As shown in FIGS. 3 and 4, the design of the apparatus 10 allows for adjustment of the flat-panel display 50 in five different ways for optimal viewing while minimizing cost, size, and complexity—a significant advance in the art.

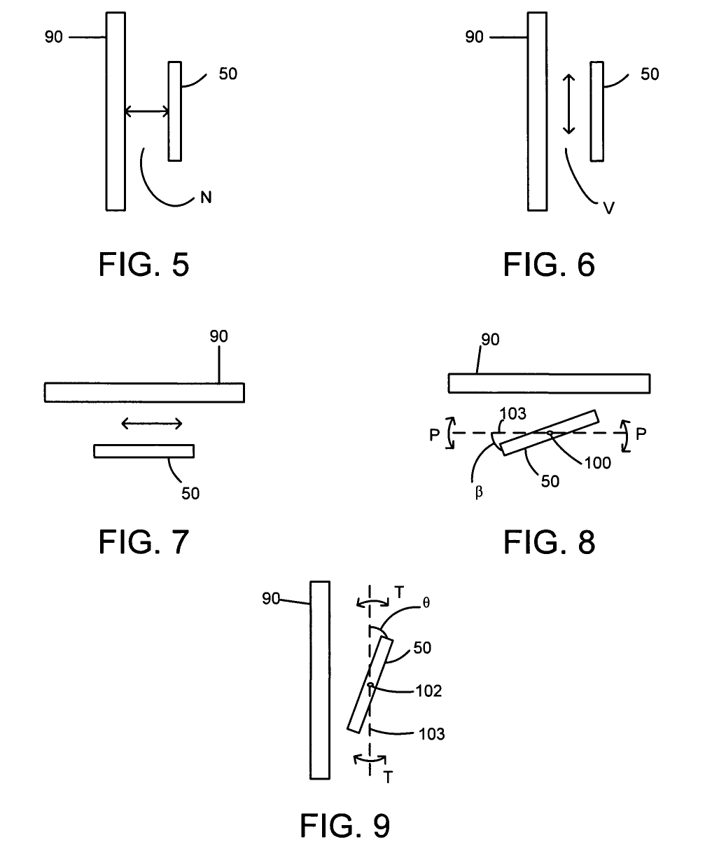

The specific ways of adjustment are shown in FIGS. 5-9. FIG. 5 shows a schematic representation of the flat-panel display 50 and the wall 90. The embodiment of the invention described above with regard to FIGS. 1-4 allows for translational movement of the flat-panel display 50 toward and away from the wall 90 in a direction normal or perpendicular to the wall 90, as shown by the bi-directional arrow N. As discussed above, this is carried out in the apparatus 10 by the choice of attachment points of the upper and lower arms 30 and 32 to the mounting brackets 12, i.e., attachment points farther apart result in translational movement of the flat-panel display 50 toward the wall 90, with attachment points closer together resulting in translational movement of the flat-panel display 50 away from the wall 90.

FIG. 6 shows the vertical translational movement of the flat-panel display 50 enabled by the invention with respect to the wall 90, represented by the bi-directional arrow V. In the apparatus 10 described above, this is carried out by moving the attachment points of the upper and lower arms 30 and 32 upwards or downwards on the mounting brackets 12, or by attaching the flat-panel display 50 higher or lower on the vertical attachment members 18, or a combination of the two.

FIG. 7 shows the horizontal translational movement of the flat-panel display 50 with respect to the wall 90 enabled by the invention, represented by the bi-directional arrow H. In the apparatus 10 described above, this is carried out by sliding the vertical attachment members 18 along the horizontal cross member 20, or by moving the cross member 20 horizontally through the tilt brackets 16. This can be done while the cross member 20 is attached to the tilt brackets 16 or by detaching them, making the horizontal adjustment, and reattaching them.

FIG. 8 shows the rotational panning movement of the flat-panel display 50 with respect to the wall 90 enabled by the invention, represented by the rotational arrows P. The flat-panel display 50 rotates around a vertical axis 100, deviating from a plane 103 parallel to the wall 90 by an angle 1, which in one embodiment may be up to approximately 45 degrees. In the apparatus 10, the panning movement is carried out by bringing one tilt bracket 16 closer to the wall than the other, in the manner described above.

FIG. 9 shows the rotational tilting movement of the flat-panel display 50 with respect to the wall 90 enabled by the invention, represented by the rotational arrows T. The flat-panel display 50 rotates around a horizontal axis 102, deviating from the plane 103 parallel to the wall 90 by an angle 0, which may be up to approximately 90 degrees. In the apparatus 10, the tilting movement is carried out by rotating the tilt bracket 16 and tightening the bolt 89 to secure it in position.

It should be noted that the size of the angles 0 and P may be limited by the size of the flat-panel display 50 and the nearness of the wall 90.

Variations on aspects of the described embodiment will be apparent to those skilled in the art in light of this disclosure while remaining within the scope of the invention. For example, as regards the components containing center sections and flanges, resulting in a substantially U-shaped cross section, other cross-sectional forms may be used such as square, rectangular, circular, or oval without departing from the invention's essentials. Other variations might include adding additional cross members 20, more or fewer mounting subassemblies 11, and other modifications. Components of the apparatus 10 can also be combined with others or separated into sub-components without departing from the scope of the invention.

Additionally, while flat-panel displays are used in one embodiment of the invention, other devices suitable for mounting can also be used, such as a picture, painting, billboard, etc. Such objects may not have threaded holes for mounting; accordingly, fasteners other than screws can be used to attach the object to the mounting apparatus.

The invention may also be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A display mounting apparatus, the apparatus comprising:
a mounting bracket adapted for attachment to a mounting surface;
an attachment bracket adapted for attachment to the display;
a first arm, having a proximal and a distal end, the proximal end of the first arm attaching to the mounting bracket, and the distal end of the first arm attaching to the attachment bracket at a first attachment point;
a second arm positioned approximately below the first arm, the second arm having a proximal and a distal end, the proximal end of the second arm attaching to the mounting bracket, and the distal end of the second arm attaching to the attachment bracket at approximately the first attachment point.

2. The apparatus of claim 1, wherein the attachment bracket is configured to swivel about the first attachment point.

3. The apparatus of claim 1, further comprising a plurality of mounting attachment points disposed substantially vertically on the mounting bracket, enabling the proximal end of the first arm and the proximal end of the second arm to be attached at various points along the mounting bracket, whereby the attachment bracket and display are translationally positioned comparatively close to the mounting surface when the proximal end of the first arm is attached to the mounting bracket at a mounting attachment point comparatively far from the mounting attachment point at which the proximal end of the second arm is attached to the mounting bracket, and whereby the attachment bracket and display are translationally positioned comparatively far from the mounting surface when the proximal end of the first arm is attached to the mounting bracket at a mounting attachment point comparatively close to the mounting attachment point at which the proximal end of the second arm is attached to the mounting bracket, and whereby the height of the display corresponds to the height of the mounting attachment points at which the first and second arms are attached to the mounting bracket.

4. The apparatus of claim 1, wherein the attachment bracket comprises a tilt bracket, the first attachment point being positioned on the tilt bracket, the tilt bracket being configured to rotate around the first attachment point allowing for tilting movement of the display, the apparatus further comprising an attachment mechanism positioned on the second arm and a curved slot disposed in the tilt bracket, the attachment mechanism being configured to attach to the tilt bracket at any point along the length of the curved slot.

5. The apparatus of claim 1, wherein the attachment bracket comprises a tilt bracket attached to the distal end of the first arm and the distal end of the second arm, the apparatus further comprising a cross member attached to the tilt bracket, the cross member being adapted for horizontal movement through the tilt bracket.

6. The apparatus of claim 5, further comprising a vertical attachment member attached to the cross member along any point of the cross member, the vertical attachment member being attached to the display.

7. The apparatus of claim 6, wherein the cross member is slidably attached to the vertical attachment member, such that the cross member is configured to slide through the vertical attachment member.

8. The apparatus of claim 6, wherein the vertical attachment member contains a plurality of vertical attachment points whereby the display can be attached to the vertical attachment member, allowing for a plurality of positions of the display relative to the vertical attachment member.

9. The apparatus of claim 6, wherein the vertical attachment member is elongated, and further comprising an elongated vertical extension, a first end of the vertical extension being configured to attach to a first end of the vertical attachment member.

10. The apparatus of claim 5, wherein the mounting bracket, first arm, second arm, and tilt bracket collectively constitute a first mounting assembly, the apparatus further comprising a second mounting assembly, the second mounting assembly also comprising a mounting bracket, first arm, second arm, and tilt bracket of similar construction to the mounting bracket, first arm, second arm, and tilt bracket of the first mounting assembly, the mounting bracket of the second mounting assembly being adapted for attachment to the mounting surface horizontally distant from the location at which the mounting bracket of the first mounting assembly is attached to the mounting surface, and the tilt bracket of the second mounting assembly being adapted for attachment to the cross member horizontally distant from the location at which the tilt bracket of the first mounting assembly is attached to the cross member, whereby the display can be panned by positioning the tilt bracket and mounting bracket of the first mounting assembly closer to each other than the tilt bracket and mounting bracket of the second mounting assembly.

11. The apparatus of claim 10, wherein the apparatus is configured for adjustment of the display in five different directions, the directions comprising: tilting the display around a horizontal axis; panning the display around a vertical axis; translationally moving the display toward or away from the mounting surface; translationally moving the display vertically; and translationally moving the display horizontally.

12. A display mounting apparatus capable of positioning and orienting the display in five different directions—tilting, panning, and translational movement vertically, horizontally, and normal to the mounting surface—the apparatus comprising:
mounting means for mounting the display to a mounting surface;
scissor means for moving the display normal to the mounting surface;
scissor means for panning the display;
tilting means for tilting the display;
means for moving the display vertically; and
means for moving the display horizontally.

13. The adjustable display mounting apparatus of claim 12, wherein the scissor means comprises a plurality of arms extending from the mounting means, the arms being configured for movement relative to each other.

14. The adjustable display mounting apparatus of claim 12, wherein the scissor means comprises a single articulated arm extending from the mounting means, the joint of the articulated arm being disposed at or near the tilting means.

15. A display mounting apparatus, the apparatus comprising:
an elongated, articulated mounting arm, the arm comprising a first end, a second end, and a joint between the first and second ends, the joint being configured for articulation of the mounting arm such that the first and second ends can be moved closer together or farther apart from each other, depending on the degree of articulation;
a first attachment mechanism positioned on the first end;
a second attachment mechanism positioned on the second end;
wherein the first and second attachment mechanisms are configured to attach to a mounting surface, and the mounting arm is configured to attach to the display at or near the joint.

16. The apparatus of claim 15, further comprising a mounting bracket configured for attachment to the mounting surface, the first and second attachment mechanisms being configured for attachment to any of a plurality of mounting attachment points along the mounting surface.

17. The apparatus of claim 15, further comprising a horizontal member configured for attachment to the mounting arm at or near the joint in sliding engagement, and a vertical member configured for attachment to the horizontal member at a plurality of points along the horizontal member, the vertical member being configured to attach to the display at a plurality of points.

18. The apparatus of claim 15, further comprising a tilt bracket disposed at the attachment point between the joint and horizontal member, the tilt bracket being configured to rotate around the attachment point.

19. A display mounting apparatus, the apparatus comprising:
first and second mounting assemblies, each assembly comprising a mounting bracket adapted for attachment to a wall or other surface, a swivel bracket, an upper arm adapted for attachment to the mounting bracket at a first end and to the swivel bracket at a second end, a lower arm disposed substantially below the upper arm, the lower arm being adapted for attachment to the mounting bracket at a first end and to the swivel bracket at a second end, the swivel bracket being configured to attach to the second ends of the upper and lower arms at substantially the same attachment point and to swivel around an axis on which the attachment point lies, and the first and second mounting assemblies being adapted for attachment to the wall or other surface horizontally distant from each other;
a horizontal member configured to slidingly engage the swivel brackets of the first and second mounting assemblies;
first and second vertical members configured for attachment to any one of a plurality of points along the horizontal member, the vertical members being configured to attach to the display in mounting engagement at a plurality of points along the vertical members.

20. The display mounting apparatus of claim 19, wherein the mounting bracket contains a plurality of potential attachment points for the first ends of the upper arm and the lower arm, wherein the display can be moved toward or away from the wall or other surface by the arrangement of the first ends on the mounting bracket, and wherein the display can be panned by causing the distance between the first ends of the first mounting assembly to differ from the distance between the first ends of the second mounting assembly when they are attached to their respective mounting brackets.

21. A flat panel display mounting system, the system comprising:
a flat panel display;
a mounting bracket adapted for mounting on a wall or other mounting surface;
a tilt bracket;
a first arm, having first proximate and distal ends, the first proximate end being attached to the mounting bracket and the first distal end being attached to the tilt bracket at a first attachment point;
a second arm, having second proximate and distal ends, the second proximate end being adapted for attachment to the mounting bracket and the second distal end being adapted for attachment to the tilt bracket at a second attachment point, enabling the tilt bracket to swivel about the axis defined by the first and second attachment points;
a horizontal member adapted for attachment to the tilt bracket, the horizontal member being adapted for horizontal movement through the tilt bracket;
a vertical member adapted for attachment to the horizontal member, the vertical member being adapted for attachment to a flat panel display or similar device.

22. The flat-panel display mounting system of claim 21, wherein the mounting bracket, the tilt bracket, and the first and second arms collectively constitute a first mounting assembly, and further comprising a second mounting assembly of similar construction to the first mounting assembly, the first and second mounting assemblies being configured to place their respective tilt brackets selectively closer or farther away from their respective mounting brackets, enabling translational movement of the flat-panel display toward or away from the wall or other mounting surface, as well as rotational panning movement of the flat-panel display.

23. The flat-panel display mounting system of claim 21, wherein the first and second attachment points are substantially the same point.

24. The flat-panel display mounting system of claim 21, wherein the vertical member is configured to attach to the horizontal member at any of a plurality of points on the horizontal member, and further comprising a slot disposed on the vertical member configured to receive screws for attaching to the flat-panel display.
